(19) United States
(12) Patent Application Publication
(10) Pub. No.: US 2005/0189247 A1
(43) Pub. Date: Sep. 1, 2005

(54) Computer cover

(76) Inventor: Richard Traugh, Tehachapi, CA (US)

Correspondence Address: LITMAN LAW OFFICES, LTD, PO BOX 15035, CRYSTAL CITY STATION, ARLINGTON, VA, 22215, US

(21) Appl. No.: 11/047,616

(22) Filed: Feb. 2, 2005

Related U.S. Application Data
(60) Provisional application No. 60/543,916, filed on Feb. 13, 2004.

(51) Int. Cl. B65D 85/00; G06F 1/20

(52) U.S. Cl. 206/320; 150/165

(57) ABSTRACT

The computer cover is a specially constructed cover for computers adapted to cover the entire computer case or monitor, including the vents and fans. The cover is constructed using a durable polyester material containing a plurality of uniform micron openings. The material may be treated with a hydrophobic process. The resulting material is water repellant, yet filters out dust and debris without detrimentally hindering airflow. The computer cover has a sleeve for wire and port protection in the rear of the computer and a flap positioned to allow access to the computer disk drives. The sleeve has a strap for tightening the sleeve around the wires. The flap, when closed, completely seals and protects the disk drives.

### CROSS-REFERENCE TO RELATED APPLICATION

This application claims the benefit of U.S. Provisional Patent Application Ser. No. 60/543,916, filed Feb. 13, 2004.

### BACKGROUND OF THE INVENTION

1. Field of the Invention

The present invention relates to protective covers, and particularly to a cover for computer components that covers the components as completely as possible, ventilation system included, and need not be removed even while the computer is in use.

2. Description of the Related Art

In light of such notorious computer troubles such as system crashes, viruses, worms and spam, a subtle problem may be gathering in the background unnoticed. The nature of its slow buildup pace leaves it easily overlooked, but dust gathering within a computer can grow to become the source of destruction for a computer. As the cooling fans blow, an air stream, its pattern dependent on the fan configuration, moves across the inner components. The air gathers dust from the outside and heat from the inside as it moves around the wires, circuits and chips within the computer and flows out of the computer case. If dust builds up at any point and hinders or obstructs the airflow, various parts may overheat. Overheating begets a variety of problems. The computer may slow down, freeze, become unstable, or even crash.

The greater danger lies in the difficulty of, identifying the true source of the problem. When facing sporadic malfunctions due to periodic overheating, it is often presumed there is a software problem, rather than a clog of dust built up within the machine. If the situation continues unaddressed long enough, the repeated overheating will eventually damage the hard drive, Central Processing Unit (CPU), power supply, or video card of the computer beyond repair.

In order to prevent this problem, various computer dust covers have been invented. Often power supply fans draw in air from vents in the front and/or sides of the computer case and blow the air out at the back of the computer case. In such a configuration, many dust covers that leave the rear of the, computer case exposed while covering the side and front vents. However, many fans today also draw in air and redirect it from the back of the computer case near the fan itself. Consequently, leaving these vents near the fans exposed while covering the rest of the chassis no longer addresses the initial, problem sought to be solved. In addition, leaving the fan exposed while covering the vents does not prevent dust from building up within the fan vent itself during off times, nor does it protect the fan and power supply from the elements of the environment if the computer is in a location with a large amount of dust or debris in the air, from high humidity, or from occasional accidental liquid spills.

There is a need for a protective dust cover that covers the fan and nearby rear vents as well, but is porous enough to allow a sufficient intake and outtake of air and heat.

U.S. Pat. No. 5,772,293, issued Jun. 30, 1998 to R. J. Hughes, discloses a dust cover for computer components designed primarily for computer monitors. The cover is constructed of a cotton/spandex blend material and includes a ventilation flap on the top, a ventilation opening in the back and an opening in the bottom for the monitor stand.

U.S. Pat. No 4,932,524, issued Jun. 12, 1990 to Hodson, describes a computer cover constructed preferably of woven nylon coated with a static charge resistant material. The cover includes at least one flap for disc drive access and has openings for the cooling fan and rear vents.

U.S. patent Publication No. 2003/0178114, published Sep. 25, 2003, describes a computer cover component that attaches to the front of a computer case or monitor for the purpose of covering buttons to prevent children from playing with them while using the computer. The cover also includes speaker holes, ventilation holes, and an access panel that may be opened to reach disc drives.

U.S. Pat. No. 5,163,870, issued Nov. 17, 1992 to D. C. Cooper, discloses a computer cover constructed of plastic sheet material, such as acrylic. The cover includes an exhaust fan and openings for the power cable and other wires located in the rear, and a sliding door in the front for access to the disc drive.

U.S. Pat. No. 6,209,973, issued Apr. 3, 2001 to K. F. Steinberg, discloses a computer monitor cover that includes a series of ventilation holes on the top, pockets attached to the sides, and ornamental appendages resembling parts of fictional characters attached to the front.

Other patents showing computer covers include U.S. Des. Pat. No. 373,348, issued Sep. 3, 1996 to E. W. Carlson (computer cover ornamental design); U.S. Des. Pat. No. 382,260, issued Aug. 12, 1997 to F. C. Smith (dust cover for computer monitor); and U.S. Des. Pat. No. 389,818 issued Jan. 27, 1998 to F. C. Smith (ornamental design for flexible dust cover).

None of the above inventions and patents, taken either; singly or in combination, is seen to describe the instant invention as claimed. Thus, a computer cover solving the aforementioned problems is desired.

### SUMMARY OF THE INVENTION

The computer cover of the present invention is a specially constructed cover for computers adapted to cover the entire computer case or monitor, including the vents and fans. The cover is constructed using a durable polyester material containing a plurality of uniform micron openings and having been treated with a hydrophobic process. The resulting material is water repellant, yet filters out dust and debris without detrimentally hindering airflow. The computer cover includes a sleeve for wire and port protection in the rear of the computer and a flap positioned to allow access to the computer disk drives. The sleeve includes a strap for tightening it around the wires. The flap, when closed, completely seals and protects the disk drives.

The details of the present invention will become readily apparent upon further review of the following specification and drawings.

### BRIEF DESCRIPTION OF THE DRAWINGS

FIG. 1 is a front, environmental, perspective view of a computer cover according to the present invention.

FIG. 2 is a back, environmental, perspective view of a computer cover according to the present invention.

FIG. 3 is bottom, environmental, perspective view of a computer cover according to the present invention.

FIG. 4 is an environmental, elevation view of the disk drive access flap of a computer cover according to the present invention.

FIG. 5 is an environmental, elevation view of the wire sleeve of a computer cover according to the present invention.

Similar reference characters denote corresponding features consistently throughout the attached drawings.

### DETAILED DESCRIPTION OF THE PREFERRED EMBODIMENTS

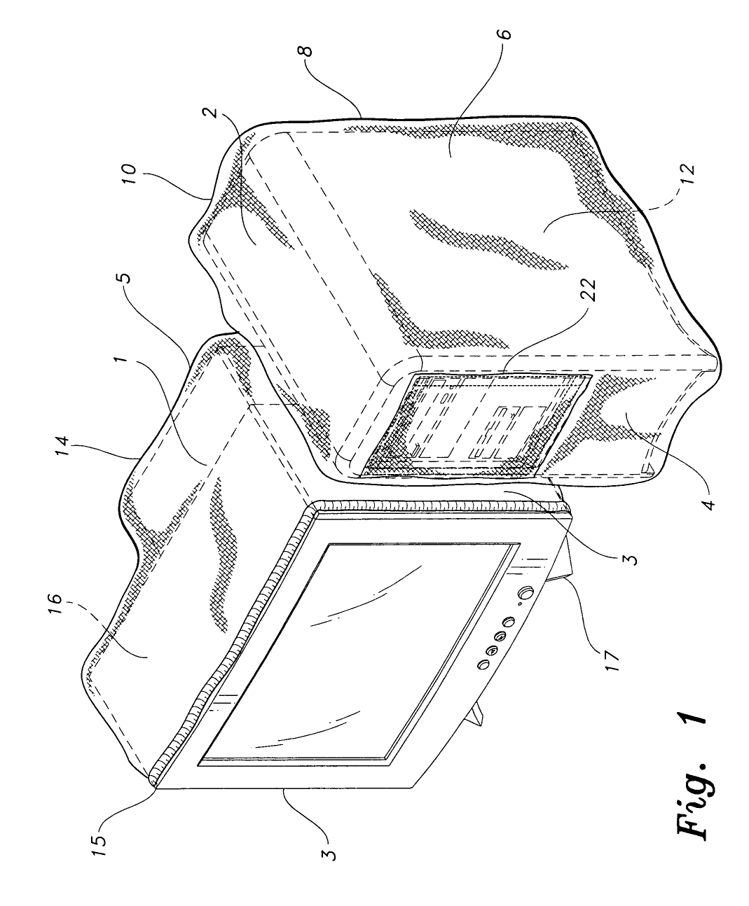

The present invention is a computer cover, designated, generally as 10 in the drawings. The computer cover 10 as shown in FIG. 1 includes a top panel 2, a front panel 4 having an optional access flap opening 22 to gain entry to the disk drive, a pair of side panels 6 and a back panel 8 having a sleeve opening for passing cables and cords through. The computer cover 10 is adapted to completely cover the computer case 12 while still providing adequate ventilation, despite the absence of ventilation openings, as will be described. Two embodiments of the computer cover 10 are disclosed herein. The first embodiment is the computer cover 10 for a computer case 12. The second embodiment is the computer cover for a monitor, designated 14 in the drawings. The computer cover for a monitor 14 is similar to the computer cover 10 except for certain modifications that will be described in greater detail later.

It should be noted that the computer cover 10 may be constructed in various sizes and shapes to accommodate various computer models without departing from the spirit of the invention. The drawings only illustrate the preferred embodiment using a tower style computer case as an example and should not be considered as limiting the invention to that type, of computer case. For example, the computer cover may be sized and dimensioned for covering a desktop computer case.

The material used to construct the computer cover 10 is preferably water repellant, yet contains openings that allow air to pass through sufficiently while filtering out dust and debris at least as small as 0.005″. The preferred material is a polyester material having a plurality of uniform micron openings, and which may also have been treated with a hydrophobic process. Testing has shown that this commercially available material efficiently filters dust while allowing adequate ventilation and avoiding excessive heat build up.

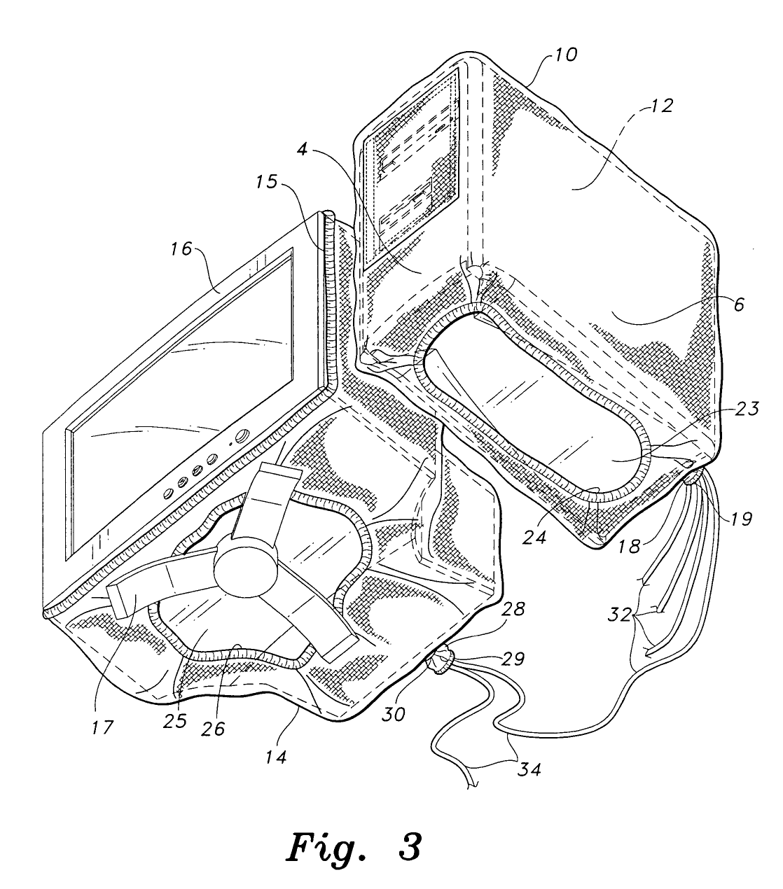

Referring to FIG. 3, the computer cover 10 includes, opposite the top section 2, a rectangular opening 23 having a resilient gather 24, which in its natural state is smaller in size than the width and length of the computer case 12 to be protected. The resilient gather 24 can be constructed of any elastomeric material, including, but not limited to, elastic, rubber, or synthetic fibers, capable of stretching and being, biased to return to an original state. In use, the resilient gather 24 is first stretched to widen the opening 23, then slid over the top of the computer case 12. The gather 24 is allowed to return to its original state once it has been positioned below the bottom of the computer case 12 after having been, pulled down the full height of the computer case 12, thereby completely and securely covering the top, front, back and sides of the computer case 12 with the computer cover 10.

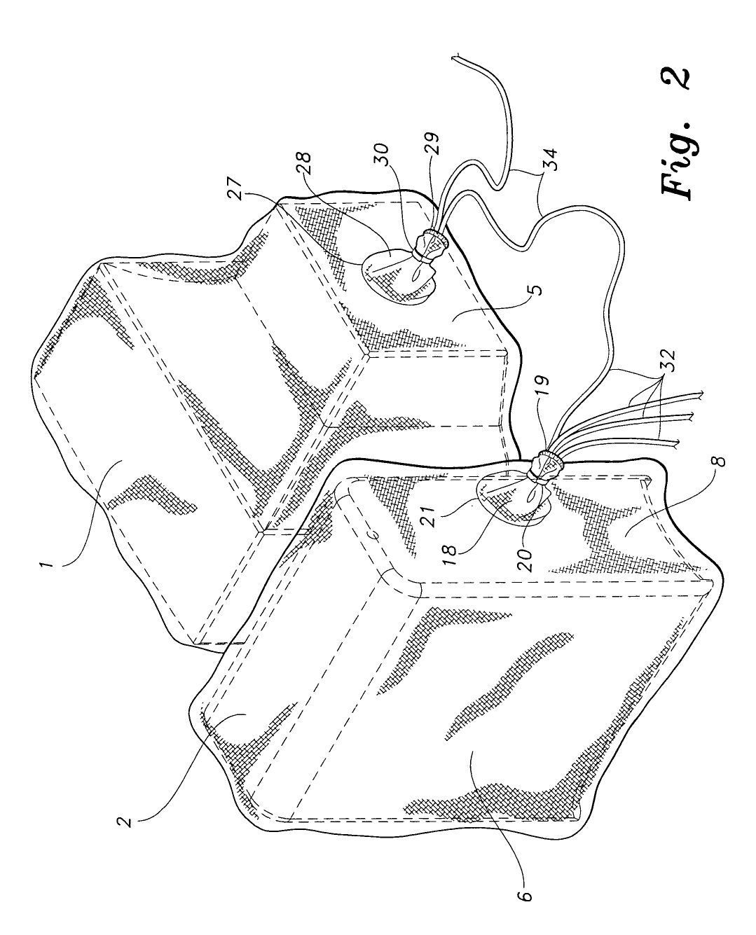

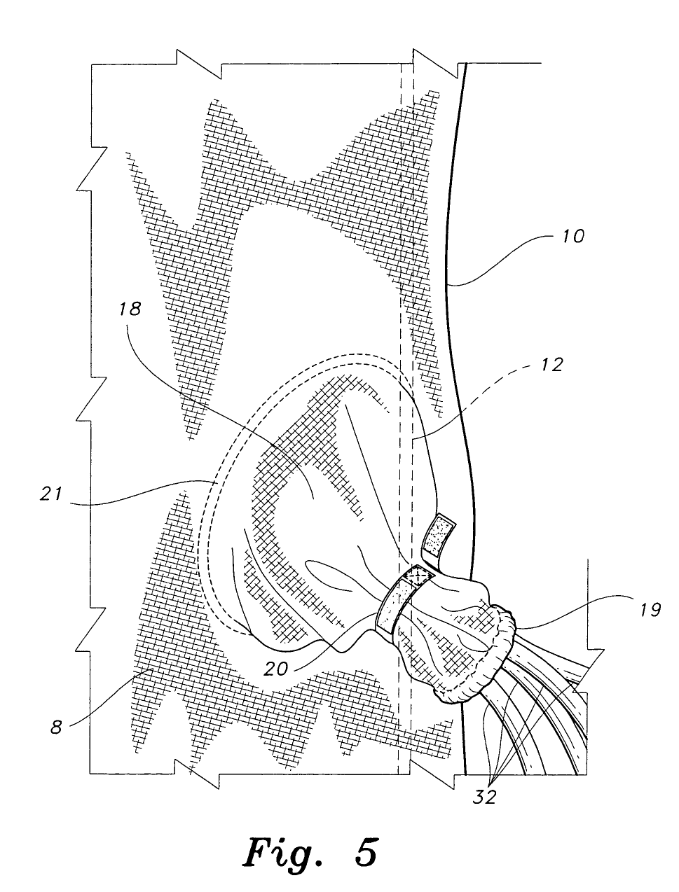

The computer cover 10 includes a wire sleeve 18 attached to the sleeve opening 21 located in the back section 8, as shown in FIG. 2. The wire sleeve 18 heightens protection of the power supply and wire ports from dust, and minimizes the number of openings and level of customization required for different variations of the computer cover 10. The wire sleeve 18 should be constructed of the same material as the computer cover 10. The size of the wire sleeve 18 is not critical, but, should preferably be approximately 3″-4″ in diameter and 3″-4″ in length. The wire sleeve 18 is attached to the opening 21 on one end and terminates at an opening with a flexible and/or resilient gather 19 on the other end. The wire sleeve gather 19 can be constructed of any flexible material, including, but not limited to, elastic, rubber, or synthetic fibers. In use, the various cables and wires 32 connected to the computer case 12, such as the power cable, mouse cord, keyboard cord and monitor cord, are all run from the computer case 12 through the wire sleeve 18 and on to their respective destinations. Referring to, FIG. 5, a tightening strap 20 is included near the end of the, wire sleeve 18 to ensure as tight a closure as possible. The tightening strap 20 may be secured by conventional means, including, but not limited to, hook and loop fasteners, snaps, a button, or a buckle.

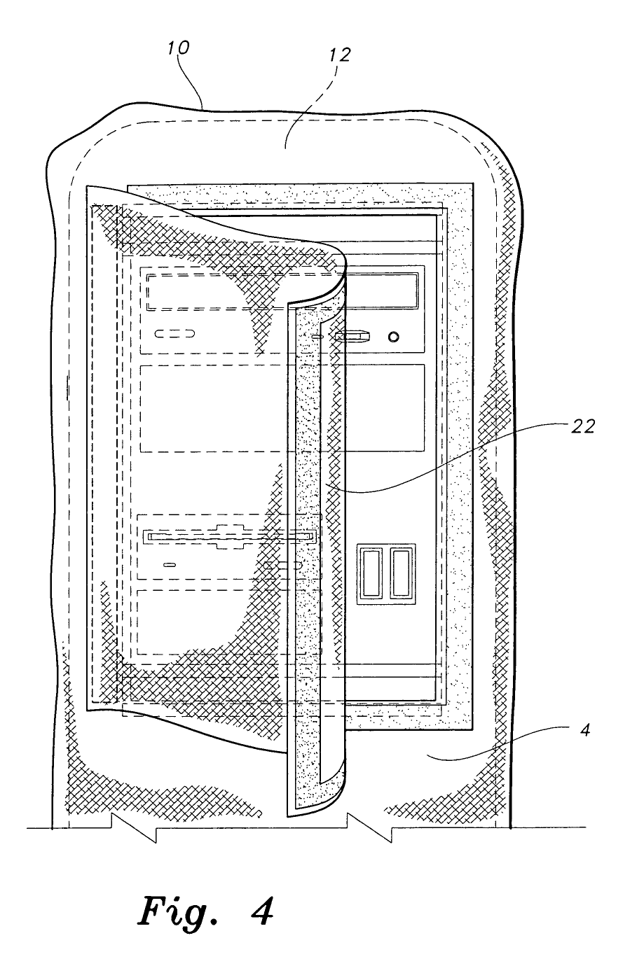

The computer cover 10 may include an access flap 22, as shown in FIG. 4, for access to the disk drives, as needed. The access flap 22 should be easily opened and closed, preferably using hook and loop fastener strips; however other means may be used, including, but not limited to, snaps, buttons, zippers or buckles. FIG. 4 illustrates the preferred, configuration of hook and look strips, with continuous strips extending around the periphery of the access opening, in order to provide a secure closure and prevent dust from entering through an opening in the flap 22.

Referring again to FIG. 1, the computer cover 14 for monitors includes a top panel 1, pair of side panels 3, and a rear panel 5. The rear panel 5 has a rear opening defined therein being dimensioned and configured for allowing monitor cables and wires 34 to exit the cover 14. Referring to FIG. 3, the computer cover 14 has a bottom opening 26 that is similar to the rectangular opening 23 of cover 10, except that it is, circular in shape rather than rectangular. This shape change is designed to fit around the cylindrical post between the monitor 16 and the monitor stand 17.

A large second opening, a screen opening 15, is positioned in front of the monitor as shown in FIG. 1 to expose the screen to the user. The screen opening 15 is shown to be square shaped; however, the opening 15 can be adapted for screens of varying size and shape as needed since it is flexible. Generally, the screen opening 15 should be smaller than the monitor screen size. This allows for a tight, snug fit between the edges of the screen opening 15 and the monitor 16. In use, after sliding the computer cover 14 over the monitor 16, the screen opening 15 will be secured around the edges of the, screen on the sides, top and bottom of the monitor 16 since an elastic gather, a resilient gather or other means, lines then screen opening 15.

As shown in FIGS. 2 and 3, the computer cover 14 also includes a wire sleeve 28 with a tightening strap 30 for the monitor cables and wires 34 to pass through. The wire sleeve 28 is disposed at the rear opening on the rear panel 5.

It is to be understood that the present invention is not limited to the embodiments described above, but encompasses any and all embodiments within the scope of the following claims.

1. A computer cover, comprising:
(a) a flexible enclosure having a top panel, a front panel, a back panel, and two opposing side panels joined together to form a cover having an open bottom, the panels being made from a material having a plurality of micron openings defined therein permitting air to flow through the panels while precluding passage of dust particles through the panels, the front panel having a disk drive opening defined therein, the back panel having a back opening defined therein dimensioned and configured for permitting passage of computer cables therethrough;
(b) a recloseable flap removably attached to the front, panel adjacent the disk drive opening, the flap covering the disk drive opening when the flap is in a closed position;
(c) a cylindrical sleeve extending from the back opening defined in the back panel, the sleeve being adapted for bundling the computer cables together;
(d) means for tightening the sleeve around the computer cables; and
(e) a resilient gather disposed around the open bottom, whereby the open bottom is drawn together under a computer cases when the cover is placed over the computer, the cover completely enclosing the computer case top, sides, front and back.

2. The computer cover of claim 1, wherein the material is treated with a hydrophobic process.

3. The computer cover of claim 1, wherein the material is water repellent.

4. The computer cover of claim 1, wherein the material is made from polyester.

5. The computer cover of claim 1, wherein the micron openings are at least 0.005″ in size.

6. The computer cover of claim 1, wherein the sleeve is made from the same material used to make the panels.

7. A computer cover, comprising:
(a) a flexible enclosure having a top panel, a rear panel, two opposing side panels, and a bottom panel joined together to form a cover defining a front opening, the panels being made from a material having a plurality of micron openings defined therein permitting air to flow through the panels while precluding passage of dust particles through the panels, the front opening being lined with a first resilient gather adapted for retaining the front opening around a monitor display screen, the bottom panel having a bottom opening therein dimensioned and configured for permitting placement of the cover over a computer monitor, the rear panel having a rear opening defined therein dimensioned and configured for permitting passage of monitor cables therethrough;
(b) a cylindrical sleeve extending from the rear opening defined in the rear panel, the sleeve being dimensioned and configured for receiving and bundling the monitor cables together;
(c) means for tightening the sleeve around the monitor cables; and
(d) a resilient gather disposed around the bottom opening defined in the bottom panel, whereby the bottom opening in the bottom panel is drawn together under the monitor above a, supporting pedestal when the cover is placed over the monitor, the cover completely enclosing the monitor above the pedestal with the exception of the display screen.

8. The computer cover of claim 7, wherein the material is treated with a hydrophobic process.

9. The computer cover of claim 7, wherein the material is water repellent.

10. The computer cover of claim 7, wherein the material is made from polyester.

11. The computer cover of claim 7, wherein the micron openings are at least 0.005″ in size.

12. The computer cover of claim 7, wherein the sleeve is made from the same material used to make the panels.

13. A computer cover kit, comprising:
(a) a flexible computer case enclosure having
(i) a top panel, a front panel, a back panel, and two opposing side panels joined together to form a computer case cover having an open bottom, the panels being made from a material having a plurality of micron openings defined therein permitting air to flow through the panels while precluding passage of dust particles through the panels, the front panel having a disk drive opening defined therein, the back panel having a back opening defined therein dimensioned and configured for permitting passage of computer cables therethrough;
(ii) a recloseable flap being removably attached to the front panel adjacent the disk drive opening, the flap covering the disk drive opening when the flap is in a closed position;
(iii) a cylindrical sleeve extending from the back opening defined in the back panel, the sleeve being adapted for bundling the computer cables together;
(iv) means for tightening the sleeve around the computer cables; and
(v) a resilient gather disposed around the open bottom, whereby the open bottom is drawn together under a computer case when the computer case cover is placed over the computer case, the computer case cover completely enclosing the computer case top, sides, front and back; and
(b) a flexible monitor enclosure having
(i) a top panel, a rear panel, two opposing side panels, and a bottom panel joined together to form a monitor cover defining a front opening, the flexible monitor enclosure being made from a material having a plurality of micron openings defined therein permitting air to flow through the flexible monitor enclosure while precluding passage of dust particles through the flexible monitor enclosure, the front opening being lined with a first resilient gather adapted for retaining the front opening around a monitor display screen, the bottom panel having a bottom opening therein dimensioned and configured for permitting placement of the monitor cover over a computer monitor, the rear panel having a rear opening defined therein dimensioned and configured for permitting passage of monitor cables therethrough;
(ii) a cylindrical sleeve extending from the rear, opening defined in the rear panel, the sleeve being dimensioned and configured for receiving and bundling the monitor cables together;
(iii) means for tightening the sleeve around the monitor cables; and
(iv) a resilient gather disposed around the bottom opening defined in the bottom panel, whereby the bottom opening in the bottom panel is drawn together under the monitor above a supporting pedestal when the monitor cover is placed over the monitor, the monitor cover completely enclosing the monitor above the pedestal with the exception of the display screen.

14. The computer cover of claim 13, wherein the material used to make the panels of the flexible computer case enclosure is treated with a hydrophobic process.

15. The computer cover of claim 14, wherein the material used to make the panels of the flexible monitor enclosure is treated with a hydrophobic process.

16. The computer cover of claim 13, wherein the material used to make the panels of the flexible computer case enclosure is water repellent.

17. The computer cover of claim 16, wherein the material used to make the panels of the flexible monitor enclosure is water repellent.

18. The computer cover of claim 13, wherein the micron openings of the flexible computer case enclosure are at least 0.005″ in size.
